(19) United States
(12) Patent Application Publication
(10) Pub. No.: US 2021/0117951 A1
(43) Pub. Date: Apr. 22, 2021

(54) METHOD, SYSTEM, AND NON-TRANSITORY COMPUTER-READABLE RECORD MEDIUM TO CHANGE PAYMENT ACCOUNT USING MESSENGER

(71) Applicant: LINE Corporation, Tokyo (JP)

(72) Inventors: Woo Seo SON, Seongnam-si (KR); Heonjae JUNG, Seongnam-si (KR)

(73) Assignee: LINE Corporation, Tokyo (JP)

(21) Appl. No.: 17/074,027

(22) Filed: Oct. 19, 2020

(30) Foreign Application Priority Data
Oct. 22, 2019 (KR) 10-2019-0131645

(51) Int. Cl. G06Q 20/22; G06Q 40/02; G06Q 30/00; G06Q 20/40; G06Q 20/10; G06Q 20/32; G06Q 20/38; H04L 12/58

(52) U.S. Cl. CPC G06Q 20/227; G06Q 40/02; G06Q 30/0185; G06Q 20/4037; H04L 51/02; G06Q 20/3223; G06Q 20/3224; G06Q 20/386; G06Q 20/108

(57) ABSTRACT

Disclosed are methods, systems, and non-transitory computer-readable record medium to change a linked account of a payment method, that is, a payment account using a messenger. A payment account changing method performed at a server comprising at least one processor configured to execute computer-readable instructions may include transmitting, to an electronic device, a message including account information about at least one account linkable to a payment method in response to a payment approval request from the payment method associated with a user of the electronic device meeting a condition, and changing a linked account of the payment method to another account included in an account change request in response to receiving the account change request from the electronic device as a response to the message.

### CROSS-REFERENCE TO RELATED APPLICATIONS

This U.S. non-provisional application and claims the benefit of priority under 35 U.S.C. § 119 to Korean Patent Application No. 10-2019-0131645, filed Oct. 22, 2019, the entire contents of which are incorporated herein by reference in their entirety.

### BACKGROUND

### Technical Field

One or more example embodiments relate to technology for changing a linked account of a payment method, that is, an account linked to the payment method.

### Related Art

In general, an electronic payment is made in such a manner that a terminal connected to a point of sale (POS) of an affiliate store acquires payment method information (e.g., a card number) of a user and requests a server of a financial company (e.g., a credit card company) for approval through a value added network (VAN) with affiliate store information and a payment amount.

### SUMMARY

Some example embodiments provide methods and/or systems that may easily and conveniently change a linked account, that is, an account linked to a payment method using a messenger.

Some example embodiments provide methods and/or systems that may immediately change a linked account of a payment method, that is, a payment account through a messenger message if a payment approval request meets a preset condition.

Some example embodiment provide methods and/or systems that may easily change a linked account of a payment method, that is, a payment account using a chatbot function of a messenger.

According to an aspect of at least one example embodiment, a payment account changing method performed at a server comprising at least one processor configured to execute computer-readable instructions includes, by the at least one processor, transmitting, to an electronic device, a message including account information about at least one account linkable to a payment method in response to a payment approval request from the payment method associated with a user of the electronic device meeting a condition, and changing, by the at least one processor, a linked account of the payment method to another account included in an account change request in response to receiving the account change request from the electronic device as a response to the message.

The transmitting may include recognizing the payment approval request as an account change event for changing the linked account in response to a failure of a payment due to an error of the linked account.

The transmitting may include recognizing the payment approval request as an account change event for changing the linked account in response to a failure of a payment due to an insufficient balance of the linked account.

The transmitting may include recognizing the payment approval request as an account change event for changing the linked account in response to at least one of affiliate store information, location information, or additional information included in the payment approval request being unmatched to information set for the linked account.

The transmitting may include recognizing the payment approval request as an account change event for changing the linked account in response to the payment approval request not corresponding to benefit information set for the linked account.

The transmitting may include generating the message that includes account information about at least one account among a plurality of accounts linkable to the payment method based on respective balances of the plurality of accounts.

The transmitting may include generating the message as an action message that includes a user interface for selecting one of a plurality of accounts linkable to the payment method to input the account change request.

The changing may include maintaining a specific account set as a main account among a plurality of accounts linkable to the payment method as the linked account of the payment method, and changing the linked account of the payment method to the another account included in the account change request during a number of times or a period of time after the account change request is received.

The changing may include changing the linked account of the payment method to the another account included in the account change request among a plurality of accounts linkable to the payment method, and maintaining the another account included in the account change request as the linked account of the payment method until a subsequent account change request following the account change request is received.

The changing may include changing the linked account of the payment method to the account included in the account change request among a plurality of accounts linkable to the payment method based on a user authentication request.

According to an aspect of at least one example embodiment, there is provided a non-transitory computer-readable record medium storing instructions that, when executed by the at least one processor, cause the server to perform the aforementioned payment account changing method.

According to an aspect of at least one example embodiment, a server includes at least one processor configured to execute computer-readable instructions included in a memory. The at least one processor is further configured to recognize a payment approval request as an account change event for changing a linked account of a payment method in response to the payment approval request from the payment method associated with a user of an electronic device meeting a condition, provide a message including account information about at least one account linkable to the payment method to the electronic device in response to recognizing the account change event, and change the linked account of the payment method to an another account included in an account change request in response to receiving the account change request from the electronic device as a response to the message.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to at least one example embodiment;

FIG. 2 is a diagram illustrating an example of an electronic device and a server according to at least one example embodiment;

FIG. 3 is a diagram illustrating an example of components includable in a processor of a server according to at least one example embodiment;

FIG. 4 is a flowchart illustrating an example of a method performed by a server according to at least one example embodiment;

FIG. 5 illustrates an example of a table in which use for each account is defined according to at least one example embodiment;

FIG. 6 illustrates an example of a table in which regional information for each account is defined according to at least one example embodiment;

FIG. 7 illustrates an example of a table in which time information for each account is defined according to at least one example embodiment;

FIG. 8 illustrates an example of a table in which benefit information for each account is defined according to at least one example embodiment;

FIG. 9 illustrates an example of a messenger screen displayed on an electronic device during a process of changing a linked account of a payment method using a messenger message in response to a payment approval request according to at least one example embodiment; and

FIG. 10 illustrates an example of a messenger screen displayed on an electronic device during a process of changing a linked account of a payment method using a chatbot function of a messenger according to at least one example embodiment.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device, however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for changing a linked account of a payment method, that is, an account linked to the payment method.

The example embodiments including the disclosures described herein may easily and conveniently change a linked account of a payment method using a messenger, and accordingly may achieve many advantages in terms of availability, convenience, efficiency, and cost saving.

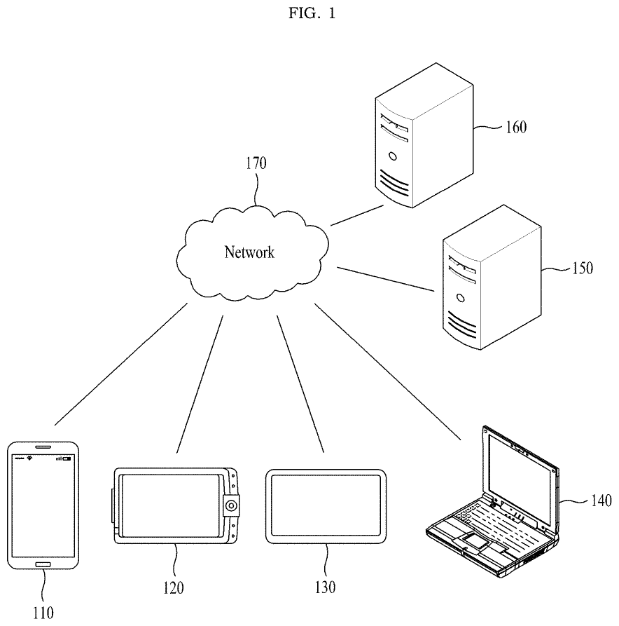

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto.

Each of the plurality of electronic devices 110, 120, 130, and 140 may be a fixed terminal or a mobile terminal that is configured as a computer system. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer systems capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer apparatus or a plurality of computer apparatuses that provides an instruction, a code, a file, content, a service, etc., through communication with the plurality of electronic devices 110, 120, 130, and 140 over the network 170. For example, the server 150 may be a system that provides a first service to the plurality of electronic devices 110, 120, 130, and 140 connected over the network 170. The server 160 may be a system that provides a second service to the plurality of electronic devices 110, 120, 130, and 140 connected over the network 170. In detail, the server 150 may provide, as the first service, a service (e.g., an Internet banking service) intended by an application through the application as a computer program installed and executed on the plurality of electronic devices 110, 120, 130, and 140. As another example, the server 160 may provide, as the second service, a service that distributes a file for installing and executing the application to the plurality of electronic devices 110, 120, 130, and 140.

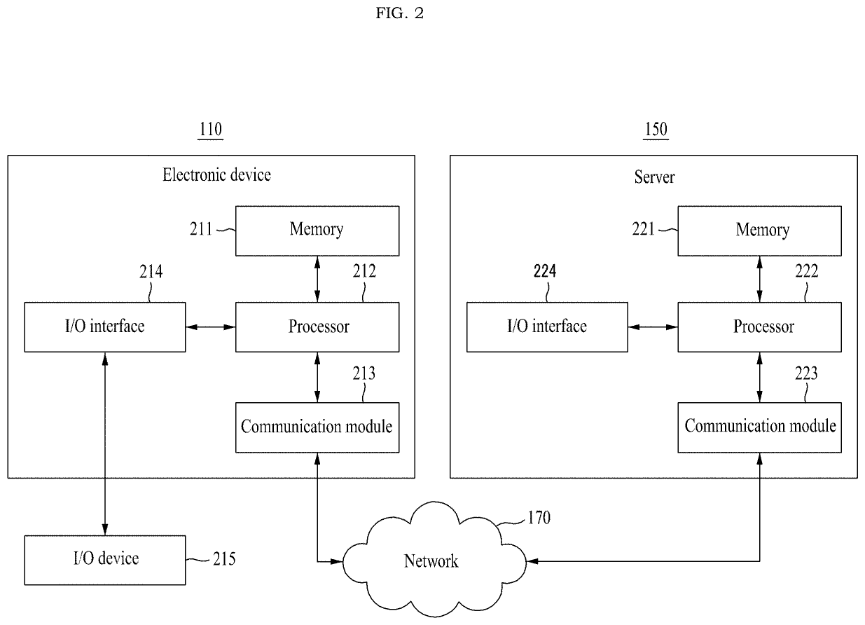

FIG. 2 is a block diagram illustrating an example of an electronic device and a server according to at least one example embodiment. Description is made using the electronic device 110 as an example of an electronic device and the server 150 as an example of a server with reference to FIG. 2. Also, the other electronic devices 120, 130, and 140 or the server 160 may have the same or similar configuration as that of the electronic device 110 or the server 150.

Referring to FIG. 2, the electronic device 110 may include a memory 211, a processor 212, a communication module 213, and an input/output (I/O) interface 214, and the server 150 may include a memory 221, a processor 222, a communication module 223, and an I/O interface 224. The memory 211, 221 may include a permanent mass storage device, such as random access memory (RAM), a read only memory (ROM), a disk drive, a solid state drive (SSD), a flash memory, etc., as a non-transitory computer-readable record medium. The permanent mass storage device, such as ROM, SSD, flash memory, and disk drive, may be included in the electronic device 110 or the server 150 as a permanent storage device separate from the memory 211, 221. Also, an OS and at least one program code, for example, a code for a browser installed and executed on the electronic device 110 or an application installed and executed on the electronic device 110 to provide a specific service, may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 211, 221 through the communication module 213, 223, instead of the non-transitory computer-readable record medium. For example, at least one program may be loaded to the memory 211, 221 based on a computer program, for example, the application, installed by files provided over the network 170 from developers or a file distribution system, for example, the server 160, providing an installation file of the application.

The processor 212, 222 may be configured to process instructions of a computer program by performing basic arithmetic operations, logic operations, and I/O operations. The computer-readable instructions may be provided from the memory 211, 221 or the communication module 213, 223 to the processor 212, 222. For example, the processor 212, 222 may be configured to execute received instructions in response to the program code stored in the storage device, such as the memory 211, 221.

The communication module 213, 223 may provide a function for communication between the electronic device 110 and the server 150 over the network 170 and may provide a function for communication between the electronic device 110 and/or the server 150 and another electronic device, for example, the electronic device 120 or another server, for example, the server 160. For example, the processor 212 of the electronic device 110 may transfer a request created based on a program code stored in the storage device such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, content, a file, etc., of the server 150 received through the communication module 213 may be transferred to the processor 212 or the memory 211, and content, a file, etc., may be stored in a storage medium, for example, the permanent storage device, further includable in the electronic device 110.

The I/O interface 214 may be a device used for interface with an I/O apparatus 215. For example, an input device may include a device, such as a keyboard, a mouse, a microphone, a camera, etc., and an output device may include a device, such as a display, a speaker, a haptic feedback device, etc. As another example, the I/O interface 214 may be a device for interface with an apparatus in which an input function and an output function are integrated into a single function, such as a touchscreen. The I/O apparatus 215 may be configured as a single device with the electronic device 110. Also, the I/O interface 224 of the server 150 may be a device for interface with an apparatus (not shown) for input or output that may be connected to the server 150 or included in the server 150. In detail, when the processor 212 of the electronic device 110 processes an instruction of a computer program loaded to the memory 211, content or a service screen configured based on data provided from the server 150 or the electronic device 120 may be displayed on the display through the I/O interface 214.

According to other example embodiments, the electronic device 110 and the server 150 may include a number of components greater than or less than a number of components shown in FIG. 2. However, there is no need to clearly illustrate many components according to the related art. For example, the electronic device 110 may include at least a portion of the I/O apparatus 215, or may further include other components, for example, a transceiver, a global positioning system (GPS) module, a camera, a variety of sensors, a database (DB), and the like. In detail, if the electronic device 110 is a smartphone, the electronic device 110 may be configured to further include a variety of components, for example, an acceleration sensor, a gyro sensor, a camera module, various physical buttons, a button using a touch panel, an I/O port, a vibrator for vibration, etc., which are generally included in the smartphone.

The term “payment method” used herein may refer to any type of payment methods capable of making a payment online/offline, including a mobile payment method capable of making a payment by registering card information or account information of various types of cards (e.g., a prepaid card, a debit card, and/or a credit card) to a messenger.

The term “linked account” refers to a bank deposit account from which an amount used by a payment method is withdrawn and may connect a plurality of accounts to a single payment method. Thus, the linked account of the payment method, that is, an account linked to the payment method may be interchangeably used with a payment account throughout. A user may pre-register a plurality of accounts linkable to a payment method among accounts of the user, and then may connect a single account among the plurality of accounts to the payment method for interaction or transaction. Also, in response to a separate request from the user, an existing account linked to the payment method may be replaced with another account.

If the balance of an account linked to a payment method is insufficient, a payment may fail. To make a repayment due to a payment failure, a proper payment amount needs to be deposited to the account linked to the payment method. In some example embodiments, the account linked to the payment method needs to be changed to another account. In the related art, a user connects to a financial company site or an exclusive application of a financial company to directly change a linked account of a payment method, that is, a payment account.

Hereinafter, methods and/or systems for changing a linked account of a payment method, that is, a payment account using a messenger according to an example embodiment is described.

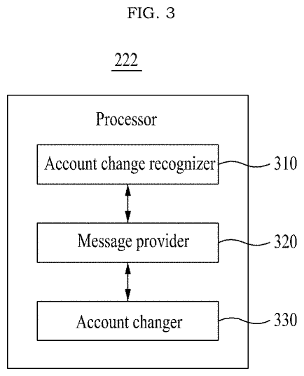

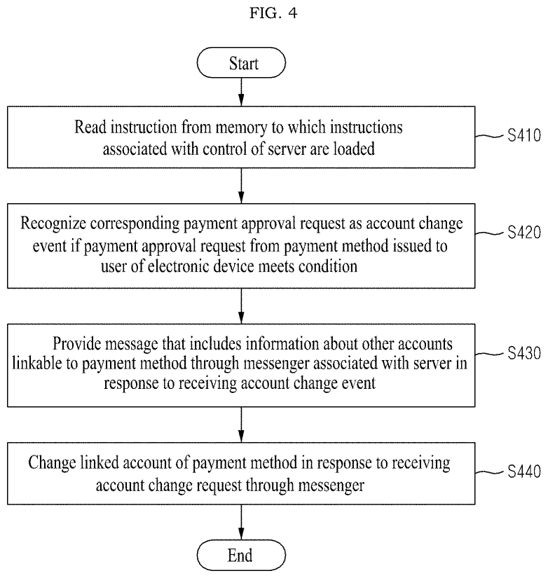

FIG. 3 is a diagram illustrating an example of components includable in a processor of a server according to at least one example embodiment, and FIG. 4 is a flowchart illustrating an example of a method performed by a server according to at least one example embodiment.

The server 150 serves as a platform that provides an Internet banking service to the plurality of electronic devices 110, 120, 130, and 140 that are clients. The server 150 may issue a payment method, such as a real card, to a service user and may pre-register an account of a corresponding bank or another bank held by the service user as an account linkable to the payment method. For example, the server 150 according to the example embodiment may provide a function of setting a single account among a plurality of accounts pre-registered through interaction with an application, that is, a messenger, installed on the electronic devices 110, 120, 130, and 140 and associated with the server 150 as a linked account of the payment method.

The server 150 may perform the payment account changing method of FIG. 4. To this end, the processor 222 of the server 150 may include an account change recognizer 310, a message provider 320, and an account changer 330. Depending on example embodiments, the components of the processor 222 may be selectively included in or excluded from the processor 222. Also, depending on example embodiments, the components of the processor 222 may be separated or merged for representations of functions of the processor 222.

The processor 222 and the components of the processor 222 may control the server 150 to perform operations 5410 to 5440 included in the payment account changing method of FIG. 4. For example, the processor 222 and the components of the processor 222 may be configured to execute an instruction according to a code of at least one program and a code of an OS included in the memory 221.

Here, the components of the processor 222 may be representations of different functions of the processor 222 performed by the processor 222 in response to an instruction provided from the program code stored in the server 150. For example, the account change recognizer 310 may be used as a functional representation of the processor 222 that controls the server 150 to recognize an account change event in response to the instruction.

Referring to FIG. 4, in operation S410, the processor 222 may read an instruction from the memory 221, to which instructions associated with control of the server 150 are loaded. In this case, the read instruction may include an instruction for controlling the processor 222 to perform the following operations S420 to S440.

In operation S420, in response to receiving a payment approval request from a payment method issued to a user of the electronic device 110, the account change recognizer 310 may determine whether the received payment approval request meets a desired (or alternatively, preset) condition. Here, if the payment approval request from the payment method meets a condition for changing a linked account of the payment method (hereinafter, also referred to as a payment account), the account change recognizer 310 may recognize the corresponding payment approval request as an account change event.

For example, payment error information may be used as a condition for changing the payment account. Here, the payment error information may be included in the payment approval request and thereby transferred to the server 150, and may refer to status information according to a payment failure caused by an issue (e.g., insufficient account balance) of the linked account. For example, the account change recognizer 310 may compare a payment amount included in the payment approval request to the balance of a linked account currently connected to the payment method and if the balance of the linked account is insufficient, that is, if a payment is disallowed due to the insufficient balance, may recognize the corresponding payment approval request as an account change event.

As another example, affiliate store information may be used as the condition for changing the payment account. The account change recognizer 310 may determine whether category information (e.g., a business type classification code) of an affiliate store included in the payment approval request matches information set for the linked account, and if the category information of the affiliate store included in the payment approval request does not match information for the linked account currently connected to the payment method, may recognize the corresponding payment approval request as an account change event.

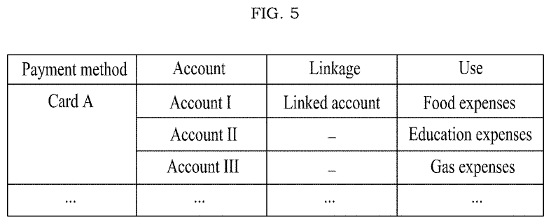

FIG. 5 illustrates an example of a table in which use for each account is defined according to at least one example embodiment.

Referring to FIG. 5, it is assumed that, among accounts held by the user, account I, account II, and account III are pre-registered as accounts linkable to card A that is a payment method of the user, and account I is currently connected as a linked account of the card A that is the payment method. Here, account I may be set as an account for food expenses, account II may be set as an account for education expenses, and account III may be set as an account for gas expenses by the user of the card A. If the user uses the card A at an educational institution and the server 150 receives a payment approval request for the corresponding use, the server 150 may acquire information indicating that a business type of the corresponding affiliate store corresponds to the educational institution based on affiliate store information included in the received payment approval request. The account change recognizer 310 may determine that the business type, that is, the educational institution, does not match the use (food expenses) of account I that is the current linked account and here, may recognize the corresponding payment approval request as an account change event.

As another example, location information may be used as the condition for changing the payment account. The account change recognizer 310 may determine whether location information (e.g., global positioning system (GPS) information) included in the payment approval request or location information acquirable from affiliate store information included in the payment approval request matches regional information set for the linked account and, if the location information does not match the regional information of the linked account currently connected to the payment method, may recognize the corresponding payment approval request as an account change event.

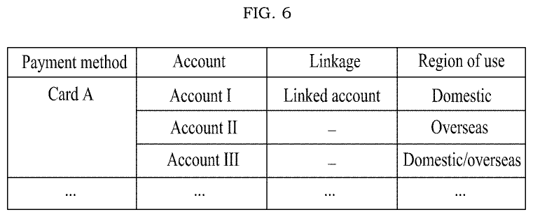

FIG. 6 illustrates an example of a table in which regional information for each account is defined according to at least one example embodiment.

Referring to FIG. 6, it is assumed that, among accounts held by the user, account I, account II, and account III are pre-registered as accounts linkable to card A that is a payment method of the user, and account I is currently connected as the linked account of the card A. Here, account I may be set as an account for domestic use, account II may be set as an account for overseas use, and account III may be set as an account for domestic and overseas use by the user of the card A. The server 150 may receive location information of the user included in the payment approval request or affiliate store information included in the payment approval request from the electronic device 110 of the user or a point-of-sale (POS) terminal. If the user uses the card A at an overseas affiliate store and the server 150 receives a payment approval request for the corresponding use, the server 150 may acquire location information of the user or the affiliate store from the received payment approval request and may verify that the corresponding location information is overseas. The account change recognizer 310 may determine that a region of use (domestic) of account I that is the current linked account and the location information (overseas) of the payment approval request do not match, and here, may recognize the corresponding payment approval request as an account change event.

As another example, time information may be used as the condition for changing the payment account. The account change recognizer 310 may determine whether time information included in the payment approval request and time information set for the linked account match, and if the time information included in the payment approval request does not match time information of the linked account currently connected to the payment method, may recognize the corresponding payment approval request as an account change event.

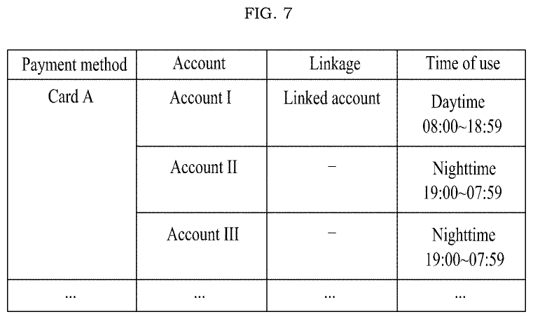

FIG. 7 illustrates an example of a table in which time information for each account is defined according to at least one example embodiment.

Referring to FIG. 7, it is assumed that, among accounts held by the user, account I, account II, and account III are pre-registered as accounts linkable to card A that is a payment method of the user, and account I is currently connected as the linked account of the card A. Here, account I may be set as an account used during the daytime (e.g., 08:00-18:59) and account II and account III may be set as accounts used during the nighttime (e.g., 19:00-07:59) by the user of the card A. If the user uses the card A at 21:05 and the server 150 receives a payment approval request for the corresponding use, the server 150 may determine that time information (21:05) included in the received payment approval request does not match time information (day time 08:00-18:59) of the account I that is the current linked account and may recognize the corresponding payment approval request as an account change event.

As another example, benefit information of an account may be used as the condition for changing the payment account. The account change recognizer 310 may determine whether the payment approval request corresponds to benefit information set for the linked account currently connected to the payment method. If the payment approval request is not associated with the benefit information set for the linked account currently connected to the payment method or if the payment approval request is not associated with benefit information set for the linked account currently connected to the payment method, but is associated with benefit information set for another pre-registered account as a determination result, the account change recognizer 310 may recognize the corresponding payment approval request as an account change event.

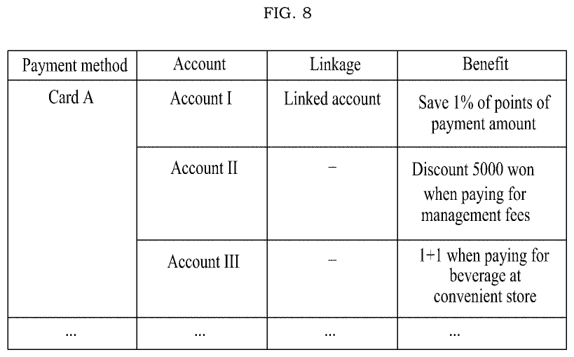

FIG. 8 illustrates an example of a table in which benefit information for each account is defined according to at least one example embodiment.

Referring to FIG. 8, it is assumed that, among accounts held by the user, account I, account II, and account III are pre-registered as accounts linkable to card A that is a payment method of the user, and account I is currently connected as the linked account of the card A. Here, account I may include a benefit for saving 1% points of a payment amount, account II may include a benefit for discounting 5000 won when paying for management fees, and account III may include a buy-one-get-one-free benefit “1+1” when paying for a beverage at a convenient store. If the user uses the card A to pay management fees and the server 150 receives a payment approval request for the corresponding use, the account change recognizer 310 may determine that the corresponding payment approval request is not associated with benefit information set for account I that is the current linked account of the card A and is associated with benefit information set for another account, that is, account II, based on affiliate store information or additional information included in the payment approval request. As another example, the account change recognizer 310 may retrieve benefit information for each account and may determine whether there is an account that includes a benefit associated with the payment approval request. As described above, if the payment approval request (payment for management fees) is not associated with benefit information set for account I that is connected as the linked account to the card A, but is associated with benefit information set for the other account, for example, account II, the account change recognizer 310 may recognize the corresponding payment approval request as an account change event.

Therefore, if payment error information, affiliate store information, location information, time information, benefit information, and/or additional information, included in the payment approval request from payment method meet a preset (or alternatively, desired) condition, the account change recognizer 310 may recognize the corresponding payment approval request as an account change event for changing the linked account of the payment method, that is, the payment account.

Referring again to FIG. 4, in operation S430, to provide the user associated with the payment method with a message (hereinafter, referred to as an account change message) including information about at least one another account different from the current linked account among accounts pre-registered as an account linkable to the payment method in response to recognizing the account change event, the message provider 320 may transmit the account change message to the electronic device 110 of the user through the server 150. Here, the account change message may be configured as an action message that includes a user interface (UI) that allows the user of the electronic device 110 to select an account to be linked and input an account change request. According to an example embodiment, the message provider 320 may retrieve the user associated with the payment method and may transmit the account change message through a messenger using user information of the retrieved user.

The account change message may include account information about all of the remaining accounts excluding the current linked account among the pre-registered accounts or partial account information based on the payment approval request. The account information included in the account change message may include at least one of an account name (e.g., an account nickname) set by the user and a partially masked account number. For example, if the balance of the linked account is insufficient, the message provider 320 may generate the account change message that includes information of an account with the largest balance among the remaining accounts excluding the current linked account or the account change message that includes information for each account sorted in descending order of the balance. As another example, the message provider 320 may generate the account change message that includes information of an account including at least a portion of information corresponding to the payment approval request among the remaining accounts excluding the current linked account (or information associated with a condition for changing a linked account of a payment method, for example, affiliate store information, location information, time information, and/or benefit information). Here, the message provider 320 may provide the user of the electronic device 110 with a notification message for the payment approval request and the account change message together through the messenger. The notification message may include at least a portion of information included in the payment approval request, for example, a payment approval request time, affiliate store information, and/or a payment amount, and may also include payment error information, for example, the insufficient balance.

In operation S440, in response to receiving the account change request through the messenger from the electronic device 110 as a response to the account change message, the account changer 330 may change the linked account of the payment method issued for the user of the electronic device 110 from a current account to another account. The account change request may include information about an account specified or selected by the user of the electronic device 110 through the account change message. Here, the account changer 330 may change the linked account of the payment method, that is, the payment account to the account specified by the user. For example, the account changer 330 may maintain an account set as a main account or a default account among the pre-registered accounts as the linked account of the payment method. Here, if the account change request is received, the account changer 330 may temporarily change the linked account of the payment method to an account included in the account change request during a preset (or alternatively, desired) number of times or a preset (or alternatively, desired) period of time with respect to a corresponding payment approval request. Here, if the preset (or alternatively, desired) number of times or period of time elapses, the account set as the main account or the default account among the pre-registered accounts may be automatically updated as the linked account. Also, a number of times or a period of time may be changed based on settings of the server 150 or a request from the user. For example, if a payment according to the payment approval request is made once immediately after the linked account of the payment method is changed to the account included in the account change request, the linked account of the payment method may be updated with the main account without a separate request from the user. Depending on example embodiments, for example, if the linked account of the payment method is changed to the account included in the account change request based on user settings, the changed account may be maintained until a subsequent account change request is received.

The account changer 330 may change the linked account of the payment method based on a result of authenticating the user of the electronic device 110. For example, in response to receiving the account change request from the electronic device 110, the account changer 330 may perform authentication on the user of the electronic device 110 before changing the linked account of the payment method. For example, the account changer 330 may request the user of the electronic device 110 to input identification information (e.g., a personal identification number (PIN) and biometric recognition, such as a fingerprint) through the messenger. If the input identification information matches desired or pre-stored information, the account changer 330 may change the linked account of the payment method to the account included in the account change request. As another example, the account changer 330 may transmit a user authentication request to the electronic device 110, and in response to receiving a result of authenticating the user from the electronic device 110, may change the linked account of the payment method.

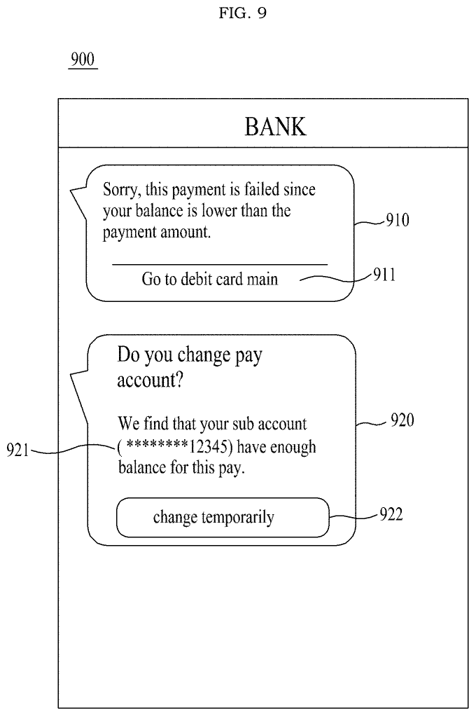

FIG. 9 illustrates an example of a messenger screen 900 displayed on a screen of the electronic device 110 during a process of changing a linked account of a payment method using a messenger message in response to a payment approval request according to at least one example embodiment.

For example, if a payment fails due to the insufficient balance of the linked account during a process of using, by the user of the electronic device 110, the payment method, the server 150 may verify whether an account with the balance greater than a payment amount included in the payment approval request is present among accounts pre-registered by the user.

If the account with the sufficient balance for the payment is present, the server 150 may transmit a message for inducing an account change to the user through a messenger installed on the electronic device 110 of the user.

Referring to FIG. 9, the electronic device 110 may receive and display a payment failure message 910 and an account change message 920 from the server 150 through the messenger. If an account with the balance greater than a payment account included in the payment approval request is present, the server 150 may transmit all of the payment failure message 910 and the account change message 920. If the account with the balance greater than the payment amount included in the payment approval request is absent, the server 150 may transmit only the payment failure message 910.

Here, the payment failure message 910 may include a link 911 to be directed to a service page that allows the user to deposit an amount to the current linked account of the payment method as a notification message to the payment approval request. The account change message 920 may include account information 921 (e.g., an account nickname and a partially masked account number) about the account with the balance greater than the payment amount included in the payment approval request, and a user interface (UI) button 922 for immediately changing the linked account of the payment method to a corresponding account. If a plurality of accounts has the balance greater than the payment amount included in the payment approval request, the account change message 920 may include the account information 921 and the UI button 922 only for an account with the largest balance or may include the account information 921 and the UI button 922 for each of accounts that are sorted based on the balance.

If the user presses the UI button 922, the electronic device 110 may transfer an account change request to the server 150 as a response to the account change message 920. Here, the server 150 may change the linked account of the payment method (e.g., the payment account) in response to the account change request.

Therefore, if the account change is desired based on a payment failure according to the insufficient balance of the linked account and information corresponding to the payment approval request (affiliate store information, location information, time information, and benefit information), the server 150 may easily and quickly change the linked account of the payment method using the messenger message without a need to access an exclusive app or site through a separate path. Thus, the desired account change could be accomplished while using less computing resources and/or consuming less power of the server 150.

Aside from a case in which the payment approval request meets a preset (or alternatively, desired) condition, the server 150 may change the linked account of the payment method at a point in time requested by the user using a chatbot of the messenger.

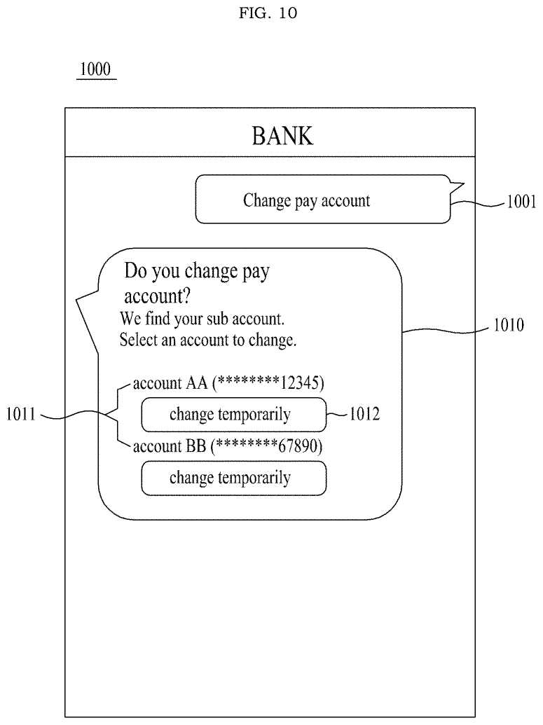

FIG. 10 illustrates an example of a messenger screen 1000 displayed on a screen of the electronic device 110 during a process of changing a linked account of a payment method using a chatbot function of a messenger according to at least one example embodiment.

Referring to FIG. 10, the electronic device 110 may provide a chatbot function associated with the server 150 through the messenger and may call an account change function in response to a user input using natural language processing of a chatbot or menu choice alternatives. If the user clicks menu choice alternatives for changing the linked account of the payment method or utters voice, “Change pay account”, the electronic device 110 may recognize the click or the utterance and may transmit an account change request message 1001 to the server 150.

In response to receiving the account change request message 1001 from the electronic device 110, the server 150 may generate an account change message 1010 that includes information about all of the remaining accounts excluding the current linked account among pre-registered accounts and may transmit the account change message 1010 to the user of the electronic device 110.

The electronic device 110 may receive and display the account change message 1010 from the server 150 through the messenger. The account change message 1010 may include an account list 1011 that includes all of other accounts excluding the current linked account of the payment method and a UI button 1012 for immediately changing the linked account of the payment method to a corresponding account along with information (e.g., an account nickname and a partially masked account number) about a corresponding account for each of the accounts included in the account list 1011.

If the user presses the UI button 1012 of a specific account on the account list 1011, the electronic device 110 may transfer an account change request to the server 150 as a response to the account change message 1010. Here, the server 150 may change the linked account of the payment method in response to the account change request. The account change request may include information about the account selected by the user from the account list 1011. The server 150 may change the linked account of the payment method with the account selected by the user.

Accordingly, the user may readily and conveniently change the linked account of the payment method using the chatbot of the messenger at a desired point in time, without a need to access an exclusive app or site. Thus, the desired account change could be accomplished while using less computing resources and/or consuming less power of the server 150.

According to some example embodiments, it is possible to easily and conveniently change a linked account, that is, an account linked to a payment method using a messenger. For example, it is possible to immediately change the linked account of the payment method (e.g., a payment account) through a messenger message if a payment approval request meets a preset (or alternatively, desired) condition and to easily change the linked account of the payment method using a chatbot function of a messenger at a point in time desired by the user.

The systems or apparatuses described above may be implemented using hardware components, or a combination of hardware components and software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For simplicity, the description of a processing device is used as singular, however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the above-described example embodiments may be configured in a form of program instructions performed through various computer devices and recorded in non-transitory computer-readable media. The media may also include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes, optical media such as CD-ROM and DVDs, magneto-optical media such as floptical disks, and hardware devices that are specially configured to store and perform program instructions, such as read-only memory (ROM), random access memory (RAM), flash memory, and the like. Examples of other media may include recording media and storage media managed by Appstore that distributes applications or a site, a server, and the like that supplies and distributes other various types of software. Examples of program instructions include both machine code, such as produced by a compiler, and files containing higher level code that may be executed by the computer using an interpreter.

While this disclosure includes some specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. A payment account changing method performed at a server comprising at least one processor configured to execute computer-readable instructions, the payment account changing method comprising:
by the at least one processor,
transmitting, to an electronic device, a message including account information about at least one account linkable to a payment method in response to a payment approval request from the payment method associated with a user of the electronic device meeting a condition; and
changing a linked account of the payment method to another account included in an account change request in response to receiving the account change request from the electronic device as a response to the message.

2. The payment account changing method of claim 1, wherein the transmitting comprises recognizing the payment approval request as an account change event for changing the linked account in response to a failure of a payment due to an error of the linked account.

3. The payment account changing method of claim 1, wherein the transmitting comprises recognizing the payment approval request as an account change event for changing the linked account in response to a failure of a payment due to an insufficient balance of the linked account.

4. The payment account changing method of claim 1, wherein the transmitting comprises recognizing the payment approval request as an account change event for changing the linked account in response to at least one of affiliate store information, location information, or additional information included in the payment approval request being unmatched to information set for the linked account.

5. The payment account changing method of claim 1, wherein the transmitting comprises recognizing the payment approval request as an account change event for changing the linked account in response to the payment approval request not corresponding to benefit information set for the linked account.

6. The payment account changing method of claim 3, wherein the transmitting comprises generating the message that includes account information about at least one account among a plurality of accounts linkable to the payment method based on respective balances of the plurality of accounts.

7. The payment account changing method of claim 1, wherein the transmitting comprises generating the message as an action message that includes a user interface for selecting one of a plurality of accounts linkable to the payment method to input the account change request.

8. The payment account changing method of claim 1, wherein the changing comprises:
maintaining a specific account set as a main account among a plurality of accounts linkable to the payment method as the linked account of the payment method; and
changing the linked account of the payment method to the another account included in the account change request during a number of times or a period of time after the account change request is received.

9. The payment account changing method of claim 1, wherein the changing comprises:
changing the linked account of the payment method to the another account included in the account change request among a plurality of accounts linkable to the payment method; and
maintaining the another account included in the account change request as the linked account of the payment method until a subsequent account change request following the account change request is received.

10. The payment account changing method of claim 1, wherein the changing comprises:
changing the linked account of the payment method to the account included in the account change request among a plurality of accounts linkable to the payment method based on a user authentication request.

11. A non-transitory computer-readable record medium storing instructions that, when executed by the at least one processor, cause the server to perform the payment account changing method of claim 1.

12. A server comprising:
at least one processor configured to execute computer-readable instructions included in a memory,
wherein the at least one processor is configured to,
recognize a payment approval request as an account change event for changing a linked account of a payment method in response to the payment approval request from the payment method associated with a user of an electronic device meeting a condition,
provide a message including account information about at least one account linkable to the payment method to the electronic device in response to recognizing the account change event, and
change the linked account of the payment method to an another account included in an account change request in response to receiving the account change request from the electronic device as a response to the message.

13. The server of claim 12, wherein the at least one processor is further configured to recognize the payment approval request as the account change event in response to a failure of a payment due to an insufficient balance of the linked account.

14. The server of claim 12, wherein the at least one processor is further configured to recognize the payment approval request as the account change event in response to at least one of affiliate store information, location information, or additional information included in the payment approval request being unmatched to information set for the linked account.

15. The server of claim 12, wherein the at least one processor is further configured to recognize the payment approval request as the account change event in response to the payment approval request not corresponding to benefit information set for the linked account.

16. The server of claim 13, wherein the at least one processor is further configured to generate the message that includes account information about at least one account among a plurality of accounts linkable to the payment method based on respective balances of the plurality of accounts.

17. The server of claim 12, wherein the at least one processor is further configured to generate the message as an action message that includes a user interface for selecting one of a plurality of accounts linkable to the payment method to input the account change request.

18. The server of claim 12, wherein the at least one processor is further configured to,
maintain a specific account set as a main account among a plurality of accounts linkable to the payment method as the linked account of the payment method, and
change the linked account of the payment method to the another account included in the account change request during a number of times or a period of time after the account change request is received.

19. The server of claim 12, wherein the at least one processor is further configured to,
change the linked account of the payment method to the another account included in the account change request among a plurality of accounts linkable to the payment method, and
maintaining the another account included in the account change request as the linked account of the payment method until a subsequent account change request following the account change request is received.
